(19) United States
(12) Patent Application Publication
(10) Pub. No.: US 2005/0170873 A1
(43) Pub. Date: Aug. 4, 2005

(54) Interactive game apparatus

(75) Inventors: Matthew Fishbach, Piedmont, CA (US); Jason Avery, Berkeley, CA (US); Fred Babich, Oakland, CA (US); Andy Hartzell, Emeryville, CA (US); Ann Hamilton, Piedmont, CA (US); Jason Harris, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/966,837

(22) Filed: Oct. 15, 2004

Related U.S. Application Data
(60) Provisional application No. 60/512,271, filed on Oct. 17, 2003.

(51) Int. Cl. A63F 9/18; G06F 17/00; G06F 19/00; A63F 9/24

(52) U.S. Cl. 463/9; 273/430

(57) ABSTRACT

An electronic device for use by users having different levels of skill or intelligence includes a memory configured to store sets of questions, each of the sets of questions being configured to be answerable by the users having different levels of skill or intelligence; and a processor operatively coupled to the memory and configured to present the different sets of questions to the different users having different levels of skill or intelligence during a game in which the different users compete against each other.

### CROSS-REFERENCES TO RELATED APPLICATIONS

This U.S. non-provisional patent application claims the benefit of the filing date of U.S. provisional patent application No. 60/512,271, filed Oct. 17, 2003. This provisional patent application and any U.S. patents or patent applications mentioned below are herein incorporated by reference in their entireties for all purposes.

### BACKGROUND OF THE INVENTION

The present invention relates to a game playable by a number of people, and more particularly relates to a game that compensates for skill differences among players, such that the game can be competitively played by players having different skill levels.

Families have engaged in interactive game play for many years with older players typically having an advantage over younger players. The advantages older players have in game play arises from the older players having a great knowledge base, being wiser, and having more advanced motor skills than the younger players. For example, parents have an advantage in game play over their children, and older siblings have an advantage in game play over their younger siblings. The advantages of older players often lead to frustration in younger players who cannot compete in traditional games equally with their elders. Older players are also frustrated in traditional game playing in that to play a traditional game with a younger player, the older player often handicaps themselves by not playing to their fullest ability, thereby attempting to appease the frustration of the younger player. For example, the older player might intentionally answer questions incorrectly, not press game buttons with their full dexterity, or limit themselves in other ways. Younger players tend to become aware of their elders' self-handicapping and again become frustrated in their lack of ability to compete in a game equally with their elders.

Game attributes that are desirable for players are attributes that reinforce learning for younger players while still challenging older players' knowledge and/or skill base. For example, game attributes are desired that reinforce reading skills, math skills, knowledge of history, science, and the like. Some traditional games provide learning reinforcement for younger players but do not provide for younger players and older players to compete equally.

Therefore, new games are needed that are configured to engage a number of players based on each players skill level, such that the new games may be played together by players of a variety of ages and skill levels without older players handicapping themselves to help younger players be competitive playing the games.

### BRIEF SUMMARY OF THE INVENTION

One embodiment of the invention is directed to an electronic device for use by users having different levels of skill or intelligence, the device comprising: a memory configured to store sets of questions, each of the sets of questions being configured to be answerable by the users having different levels of skill or intelligence; and a processor operatively coupled to the memory and configured to present the different sets of questions to the different users having different levels of skill or intelligence during a game in which the different users compete against each other.

Another embodiment of the present invention relates to a game playable by a number of people, and more particularly relates to a game that compensates for skill differences among players, such that the game can be competitively played by players having different skill levels. In short, this is made possible by an electronic device that includes a memory configured to store sets of questions and sets of answers to the questions, each of the sets of questions being configured to be answerable by users having a select age or an age higher than the select age; and a processor operatively coupled to the memory and configured to: (i) receive at least one request for presenting questions from one or more of the sets of questions, and based on the request present at least one question from the one or more sets of questions, (ii) present a set of answers to the at least one question, (iii) receive an answer choice, (iv) determine whether the answer choice is a correct choice, and (v) award a set of points if the answer choice is the correct choice. According to a specific embodiment, the electronic device further includes an audio-output unit operatively coupled to the processor and configured to audibly present the at least one question and the set of answers to the at least one question. The electronic device might also include a plurality of sets of answer buttons, wherein the answer buttons of each of the sets of answer buttons are respectively associated with the answers to the questions, and wherein the answer buttons are configured to be activated by one or more users to present the answer choices to the processor.

According to another specific embodiment, the electronic device further includes a plurality of player-recognition buttons, wherein the processor is configured to detect a first activated player-recognition button and provide an opportunity to answer the at least one question to a user that activated the first activated player-recognition button. The electronic device might also include a plurality of sets of lights operatively coupled to the processor, each set of light being configured to be lighted by a processor command issued by the processor to indicate a total number of points associated with correctly answered questions.

According to another embodiment, an electronic game includes a processor configured to: receive a plurality of requests from users for game questions from a plurality of sets of game questions, each of the sets of game questions being configured to be answerable by users having at least a select age, wherein the select ages are different ages, and provide each of the users the game questions requested by the users during play of one or more game options. The plurality of sets of questions includes at least three sets of questions. The processor is further configured to receive bets from one or more of the users that another of the users will answer one of the questions presented to the other user incorrectly, wherein if the other user answers this question correctly, then the other user is awarded a game benefit and the one or more of the users loose a game benefit, and wherein if the other user answers this question incorrectly, then the one or more of the users will receive a game benefit.

According to another embodiment, a user interactive electronic method includes storing a set of questions that includes a plurality of subsets of questions, wherein each of the subsets of questions includes questions that are configured to be answered by users having a select age or an age higher than the select age, wherein each select age is different; receiving a plurality of requests for the subsets of questions, wherein: each of the requests is a request for one of the subsets of questions and is associated with one of the users, and each of the users is associated with one of the subsets of questions; presenting to each of the users one or more of the questions from the subset of questions that is associated with the user; presenting a set of answers for each of the questions presented to the users; receiving an answer choice for each set of answers; and awarding a game benefit for each of the received answer choices that are correct answer choices. The step of receiving the plurality of requests might include one or more of the received requests for a plurality of the subsets of questions, and one or more of the users is associated with the plurality of the subsets of questions. Further, the step of presenting to each of the users one or more of the questions might include audibly presenting the questions, and the step of presenting the set of answers for each of the questions might include audibly presenting the set of answers for each of the questions.

A further understanding of the nature and advantages of the present invention may be realized by reference to the remaining portions of the specification and the drawings.

### BRIEF DESCRIPTION OF THE DRAWINGS

FIG. 1 is a simplified top view of a game apparatus according to one embodiment of the present invention;

FIG. 2 is a simplified side view of the game apparatus according to one embodiment of the present invention;

FIG. 3 is a simplified cross-sectional view of the game apparatus according to one embodiment of the present invention;

FIG. 4 is block diagram of a circuit of the game apparatus according to an embodiment of the present invention; and

FIG. 5 is a high-level flow chart having steps for a method of playing a game according to one embedment of the present invention.

### DESCRIPTION OF SPECIFIC EMBODIMENTS

The present invention provides a game playable by a number of people, and more particularly provides a game that compensates for skill differences among players by providing age specific questions that are selectable by the players, such that the game can be competitively played by the players.

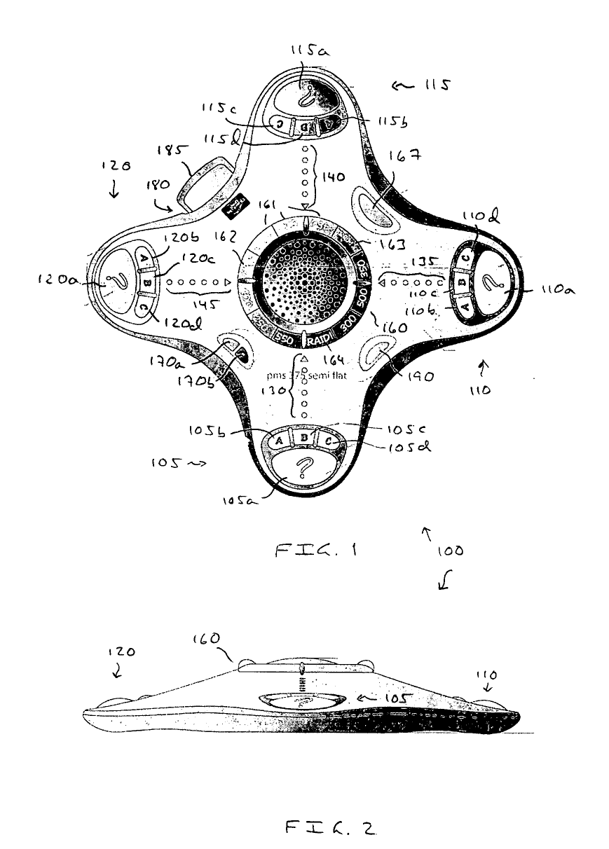

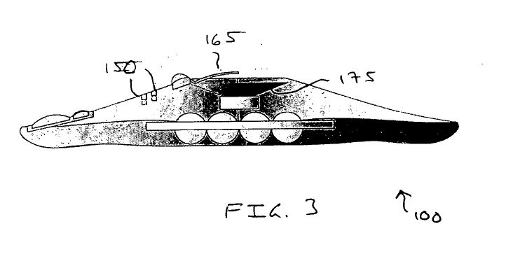

FIGS. 1 and 2 are simplified top and side views of a game apparatus 100 according to one embodiment of the present invention. The physical layout and game elements of game apparatus 100 will be briefly described first below, and methods of game play of the game apparatus will be described second below. The functions of the game elements will be described in further detail in the description of the methods of game play. According to one embodiment, game apparatus 100 includes four sets of control buttons 105, 110, 115, and 120. Each set of control buttons is configured to be associated with a player of the game apparatus. However, fewer than four players may play the game apparatus at a given time. Each set of control buttons includes a player-recognition button and a set of answer buttons that includes at least three answer buttons. The player-recognition buttons are labeled with the reference numbers 105a, 110a, 115a, and 120a, and the answer buttons are labeled with the reference number 105b-105c, 110b-110c, 115b-115c, and 120b-120c. The control buttons might be configured to light-up from lights positioned below the control buttons. Each set of control buttons might be a different color, such as red, blue, green, and yellow. Each of the three answer buttons of each set of answer buttons might be labeled with the letters A, B, and C.

The game apparatus further includes four sets of lights 130, 135, 140, and 145. Each set of lights might be in a line adjacent to an associated set of control buttons. Each set of lights might include a set of LEDs (e.g., six LEDs). Each LED in a set of LEDs might be configured to emit different colors of light, and the LEDs at a given level of the game apparatus might be configured to radiate the same color light. For example, the LEDs nearest to the sets of control buttons, might be configured to radiate blue light; the LEDs nearest the blue LEDs might be configured to radiate green light, etc. According to one embodiment, the LEDs are positioned below light pipes 150 (see the cross-sectional view of game apparatus 100 shown in FIG. 3). The light pipes might be colored according to color scheme of the LEDs described above.

The game apparatus might also include a dial 160 that might be configured to spin in response to a user rotationally pushing the dial. Such dials are often referred to as spinners. Dial 160 is configured to provide a system for point selection and option selection for game play. For example, the dial might include a number of point values 161 that might be associated with the games the game apparatus is configured to play. The dial might also include a surprise option 162, a double points option 163, and a raid option 164. These options are described in further detail below. The point values and options might be selected by a player spinning the dial and the game apparatus detecting the point value or option that aligns with a pointer 165.

According to one embodiment, the game apparatus further includes a repeat button 167 (see FIG. 1), which is described in detail below. Further, game apparatus 100 might include a speaker 175 (see FIG. 3) that is configured to be controlled by a set of volume control buttons 170. The set of volume control buttons might include an up button 170a and a down button 170b that are configured, respectively, to raise and lower the speaker volume. While FIG. 1 shows that the game apparatus includes buttons for raising and lowering the volume, other means may be used to raise and lower volume, such as control knobs, a touch pad or the like. According to one embodiment, speaker 175 has at least a three inch diameter to reproduce, in a substantially clear manner, a human voice as well of other sounds (e.g., electronic sounds).

The game apparatus might further include a memory card slot 180 that might be disposed on the side of the game apparatus. The memory card slot might be configured to receive a memory card 185 that might include game upgrades, such as new questions, software for new methods of game play or the like. The game upgrades might be transferred from the memory card to a memory that is positioned in the game apparatus.

An on/off button 190 might be disposed on a top surface of the game apparatus or on another surface and might be configured to turn the game apparatus on and off. On/off button 190 positioned on the top surface of the game provides for easy visibility of the on/off button and thereby serves to remind players (e.g., younger players) to turn the game apparatus off after game play to conserve battery power. According to one embodiment, the game apparatus might be configured for self power down if a game control has not been activated for a select period of time.

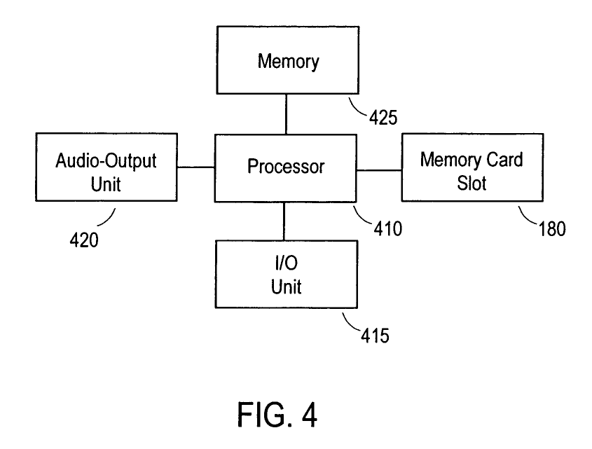

According to one embodiment, game apparatus 100 includes a control system 400 (see FIG. 4) that is configured to control game play as well as other game functions. Control system 400 might include a processor 410, an input/output (I/O) unit 415, an audio-output unit 420, a memory 425, and the memory card slot 180. One or more elements (e.g., processor 410, memory 425, memory card slot 180 or the like) of the control system might form a control circuit that might be disposed on one or more circuit boards (not shown). Processor 410 may include a microcontroller, a microprocessor, control logic or the like. The processor is configured to execute program code that might be stored in memory 425 or other memory to control the operations of the I/O unit, the audio-output unit, the memory, and the memory card slot. According to one embodiment, I/O unit 415 includes the sets of control buttons, the sets of lights, the volume control buttons, the set of on/off buttons, the reset button, and the dial. The I/O unit is configured to receive control signals from the processor, and transfer control signals to the processor. For example, the I/O unit might further be configured to receive commands from the processor to light the control buttons and/or the LEDs. Further, the I/O unit might be configured to detect the point values and options on the dial that are pointed at by the pointer, and transfer the point values and options to the processor for processing. The I/O unit if further configured to detect whether a user has activated (e.g., pressed) any of the control buttons, and transfer activation signals to the processor for processing. According to one embodiment, the audio output unit includes speaker 175 and might include one or more circuits (not shown) that are configured to control the speaker. Audio tracks that are configured to be output by the speaker might be stored in memory. The foregoing described elements of game apparatus 100 are described in further detail below as the elements become relevant to the description of the methods of game play of the game apparatus.

A number of steps are described below for selecting a game to be played by the game apparatus and for configuring a selected game for play. It should be understood that while the following description describes a specific order of steps for selecting and configuring a game for play, the described steps may be carried out in a variety of orders. The order of steps might be varied depending on a game chosen for play, the method of playing the game or the like. Therefore, the following description should be viewed as illustrative and not limiting on the claims.

According to one embodiment, game apparatus 100 is configured to play at least four different games with one to four players. The games are referred to herein as game one, game two, game three, and game four. To configure the game apparatus to play a game, a player might press a select control button that might be temporarily configured by processor 410 for game selection. For example, player-recognition buttons 105a, 110a, 115a, and 120a might be temporarily configured by the processor for game selection, such that each player-recognition button is associated with one game. Text might be positioned on or near the player-recognition buttons to indicate the respective associations between the player-recognition buttons and the games. Alternatively, an audible direction might be output by speaker 175 that informs the players of the respective associations of the four games with the four player-recognition buttons, and might further direct the players to press one of the player-recognition buttons to select a game for play. According to one embodiment, the player-recognition buttons are configured for game selection subsequent to turning the game apparatus on, at the conclusion of a previously played game or the like.

Subsequent to selecting one of the games for play, the player-recognition buttons may be reconfigured by the processor to be activated by one or more players to select the number of players who will play the game. For example, if three players plan to play a game, each player might choose a set of control buttons for use to play the game, and might press the player-recognition button in their associated set of control buttons to indicate to the game the sets of control buttons the players intend to use to play a selected game.

According to a further embodiment, the processor may be configured to reconfigure the sets of control buttons one or more additional times to receive further input from players for selecting sound effects, names, the length of a game play, group play or the like. To elaborate, the game apparatus may be configured to provide a variety of sets of sound effects (e.g., thirty sets of sound effects) that may be associated with the sets of control buttons and hence associated with the players using the sets of control buttons to play a game. Each set of control buttons might further be associated with a name from a set of names. The set of names might include mom, mommy, dad, daddy, sister, brother, best friend, grandma, grandpa, sport, champ, princess, etc. A name and sounds selected by a player might be used during game play to identify the player, for example, as a direction is directed to the player. The length of a game might be varied by the temporal length, by a number of rounds played, by a number of questions to be asked and answered or the like. As briefly described above, the game apparatus might further be configurable for team play. For example, the game apparatus might be configurable by a group of players to permit one player to play against one other player, two other players, or three other players. Or players might configure the game apparatus for two players to play against two other players. The players might be directed by output from the speaker how to select the foregoing setup options or how to bypass the setup options. Alternatively, written instructions might be provided with the game apparatus directing players how to select the foregoing playing options. According to another alternative, the sets of control buttons might be lighted in a given sequence to prompt players to make selections for the foregoing game play options. The control buttons might be lighted in combination with the audible direction to further simplify game setup by the players.

The games that game apparatus 100 is configured to play are presently described in further detail. According to one embodiment, game one is generally a question and answer game. Players may be asked questions from one or more sets of questions. Players answering questions correctly may be awarded a game bonus, such as points. The points may be used by the game apparatus to determine a winner of game one.

Each set of questions might include questions that are configured for players of a given age group. That is, the questions for a given age group are generally answerable by players of the age group or players having an age that exceeds the age group. Questions configured to be answered by players of a relatively high age group generally might not be answerable by players of a relatively lower age group. In other embodiments, the questions may be targeted to a particular skill or intelligence level of the players. According to one embodiment, the game apparatus might include three sets of questions. A first set of questions might include questions that are configured for players that are approximately five to eight years old (e.g., approximately equivalent to elementary school grades one to three). A second set of questions might include questions that are configured for players that are approximately eight to eleven years old (e.g., approximately equivalent to elementary school grades four to six). And a third set of questions might include questions that are configured for players that are approximately eleven years old and older (e.g., approximately equivalent to middle school grade seven and higher). The sets of questions might be related to educational material that is typically taught in the school grades (e.g., kindergarten, first grade, second grade, etc.) that are associated with the age groups. The sets of questions might include questions that cover life science, Earth science, geography, history, language arts, math, logic and the like. The sets of questions might include questions that are in accord with educational material that is specified by one or more educational standards, such as a state educational standard, a federal educational standard or the like. While game apparatus 100 has been described as including three age-specific sets of questions, the game apparatus might include more or fewer sets of questions that might be directed to a variety of age groups that is the same or may differ from the age groups described above.

According to one embodiment, the game apparatus is configured to store the sets of questions in memory 425. Processor 410 is configured to retrieve the question from memory 425 during game play for presentation to the players. Sets of questions might be added to the game apparatus via memory card 185. According to one embodiment, a manufacturer of the game apparatus or an independent provider may host a website at which players may download sets of new questions to memory card 185, for loading into the game apparatus.

The game apparatus is configured to permit the players of the game one to choose the sets of questions that players will receive during the play of game one. The game apparatus might be configured to audibly direct the players to select one or more sets of questions the players would like to receive questions from, and might inform the players of the age group associations of the sets of questions. For example, children that are approximately five years old might choose to receive questions from the first set of questions, whereas children that are approximately nine years old might choose to receive questions from the first and/or second sets of questions. In other embodiments, the game apparatus could automatically determine which set of questions to provide to the players. For example, the game apparatus could receive information about the ages and/or level of education of the players. Using this information, the game apparatus could automatically select appropriate question sets for the different players. According to the embodiment of game one, the questions from the one or more sets of questions chosen for play are directed to each of the players during the play of game one. It should be understood that the foregoing described set selections are exemplary, and that the players may select one or more of any of the sets of questions available for play in game one. According to one embodiment, sets of questions for game play might be selected by activating one or more of the control buttons, which might be temporarily configured by the processor or such selection. For example, the answer buttons of each set of answer buttons might be respectively associated with the sets of questions, and might be temporarily configured by the processor to receive player selection of the sets of questions. This association might be communicated to the players in the audible direction.

Subsequent to the selection of one or more sets of questions, game one may be initiated by a player spinning the dial. An audible direction output by the speaker may direct one of the players to spin the dial to start playing game one. Audible directions may be in the spoken style of a television game show host. For example, the audible directions might be humorous and or encouraging. For example, the audible directions might be witty, sarcastic or the like for older players, and might be encouraging for younger players. The approximate age of the players might be surmised by the game apparatus based on the set of questions the players choose for playing game one.

Subsequent to spinning the dial, the pointer will point to one of the numbers on the dial, to “raid!”, to “surprise”, or to “2× points.” The numbers indicates the number of points a player will receive if they answer the next asked question correctly. The point values might include 200, 250, 300, 350, 400, 450, 500, 550, 600 or other point values. The raid! option allows one player to take points from another player. For example, if the raid! option is pointed at the by pointer, the player answering the next question correctly may be allowed to take a predetermined number of points from another player. Alternatively, the dial might be spun one or more times until a number is pointed at by the pointer, such that the player answering the next question correctly will be permitted to take the number of points from another player. An audible direction might be output from the speaker announcing the raid and might include a humorous warning to the other players warning these players of the possibility of losing points to another player. If the surprise option on the dial is pointed at by the pointer, surprise games might be played by the game apparatus and might permit players to earn bonus points or loose points. For example, the speaker might output “surprise bonus points” or “surprise minus points.” If the message “surprise bonus points” is output from the speaker, the first player to press their associated player-recognition button might be awarded the bonus points. Alternatively, if the message “surprise minus points” is output by the speaker, the last player to press their player-recognition button might lose points. If the 2× points option is pointed at by the pointer, the player whose turn it is to play may spin the dial again until a number is pointed at by the pointer, and if this player answers the next question correctly, the player is awarded twice the number of points pointed at by the pointer.

According to one embodiment of game one, a player is given an opportunity by the game apparatus to answer a question and earn points if the player is the first player to press their associated player-recognition button after the question has been asked (i.e., audibly output by the speaker) and/or during the asking of a question. According to some embodiments, the processor is configured to detect temporal differences between the control buttons being activated by one-hundredth of a second or less. The player who has pushed their associated player-recognition button before the other players may be given three answer choices from which to choose a correct answer for a received question. The answer choices are audibly output by the speaker. The player might select an answer choice by pressing one of the answer buttons associated with the player. For example, the first, second, and third answers might be respectively associated with first, second, and third answer buttons having the letters A, B, and C (or other indicators) positioned thereon or near (see FIG. 1). If the player does not press the correct answer button and answers the question incorrectly, then the game apparatus may give another player an opportunity to answer the question. The other player might be the player who pressed their player-recognition button temporally closest to the player who first pressed their player-recognition button. An audible direction may be output by the speaker to indicate the other player who will be given an opportunity to answer the question. Alternatively, one of the control buttons (e.g., the player-recognition button) associated with the other player may be lighted to indicate that the other player is being given the opportunity to answer the question. If the other player answers the question correctly, the other player may collect the available points or collect a fraction of the available point (e.g., half of the available points). After the first question is answered (e.g., once or twice), the players might spin the dial again and proceed to answer questions until the game is won or the players stop playing. The speaker might output an audible direction for the players to spin the dial to proceed with another question.

Points that the players have earned might be indicated by the LEDs. Each lighted LED might indicate that a player has earned one hundred points, one thousand points or the like. If all of the LEDs associated with a player are lighted, this might indicate that the player has won game one. Alternatively, the player with the most points after the game has ended might be the winner of game one. Game one might end if a given amount of time has passed (e.g., fifteen minutes, thirty minutes, etc.), a predetermined number of questions has been asked (e.g., one hundred questions), a predetermined number of rounds of questions has been asked (e.g., ten rounds of fifteen questions per round), etc.

If game one is played in rounds of questions (e.g., ten rounds of fifteen questions per round), between the rounds, the game apparatus might be configured to present the players an option to play a “bonus game.” The speaker might output an audible direction for the players to press a select one of the control buttons to accept the option to play the bonus game, or press another of the control buttons to decline the option to play the bonus game. The bonus game might include the processor sequentially lighting the player-recognition buttons that are being used by the players, and the players pressing their associated player recognition buttons to repeat the sequence. Player-recognition buttons that are not being used by the players might not be lighted. The sequence might begin with a single player-recognition button being lighted and a single player pressing that player-recognition button. The game apparatus might lengthen the sequence by one step each time the players press the player-recognition buttons in the correct order of the sequence. Each of the players might be awarded a predetermined number of points by the game apparatus if the sequence grows to a predetermined length (e.g., twenty sequential lightings of the player-recognition buttons, e.g., in a random order) and the players correctly repeat the order of the sequence by pressing their associated player-recognition buttons. Alternatively, if one of the players fails to press their associated player-recognition button in the order of the sequence, the other players might receive a predetermined number of points, or the player having incorrectly pressed their player-recognition button might lose points. After the bonus game has concluded, additional rounds of game one are played. The speaker might output an audible direction for the players to spin the dial to proceed with another round of game one.

Game two is similar to game one in that game two is also generally a question and answer game. Game two differs from game one in that the game apparatus is configured to initially present an answer to a question and then present a number of questions, one of which is the correct question to the answer. The players are to determine the correct questions to the answers to garner points. Similar to game one, the game apparatus might audibly direct the players to select one or more sets of answers and questions that will be used to play game two. The sets of answers and questions might be organized based on age similar to the questions and answers described above with respect to game one. For example, the game apparatus might include three sets of answers and questions. Each set of answers and questions might be configured for a select age group (e.g., set one for players five to eight years of age, set two for players eight to eleven years of age, and set three for players eleven years of age and older). The game apparatus at the beginning of game two might be configured to direct the players to choose one or more sets of answers and questions that will be used for playing game two.

Play of game two might be configured to proceed similarly to game one with the game apparatus audibly directing the players to spin the dial to select a point value for an answer and its associated questions. The game apparatus may be configured to detect the first pressed player-recognition button that is pressed by a player during and/or after the answer has been audibly output by the speaker. After the first pressed player-recognition button is detected, then the questions (e.g., three questions) are audibly output by the speaker for the player to select from. The answer buttons are respectively associated with the questions, and the player may press one of the answer buttons in an attempt to identify the correct question. The game apparatus is configured to award the player the points indicated by the pointer if the correct question is identified by the player by pressing the answer button associated with the correct question. Similar to game one, a second player may be given the opportunity to identify the correct question if the first player does not identify the correct question. The second player might be a player who pressed their associated player-recognition button temporally nearest to the first pressed player-recognition button. The 2× points option, the raid! option, and the surprise option on the dial are configured to trigger game options similar to those game options described above with respect to game one. Game two might be played in rounds as described above with respect to game one, wherein bonus games offered for play between rounds. The bonus game is described in detail above. Further, game two may be won similarly to game one (see the above description of how a player may win game one).

Game three is generally a categorization game for which players press their player-recognition buttons to indicate whether they believe an answer choice is within a category. More specifically, for game three, the game apparatus is configured to audibly output a category, and ask the players to identify whether a set of answers is in the category. For example, the game apparatus might audibly output the statement, “Identify the vertebrates.” The game apparatus might then audibly output a list of animals, such as cat, bacteria, cow, jellyfish, salamander, etc. According to one embodiment, a set of answers might include twelve to fourteen members, inclusive. However, sets of answers might include other numbers of answers. After each animal's name (i.e., answer option) is audibly output, the players are given an opportunity to be the first player to press their associated player-recognition button to indicate whether the animal is a member of the category. The game apparatus is configured to detect each player-recognition button that is pressed, and detect the player-recognition button that is pressed first. If the answer (e.g., cat) is a member of the category (e.g., vertebrates), then the player that first pressed their player-recognition button is awarded points. Alternatively, if one or more players press their associated player-recognition button to incorrectly identify that the animal (e.g., jellyfish) as a member of the category (e.g., vertebrates), then each of these players will lose points.

Awarded and deducted points are tracked by the game apparatus, and each player's accumulated points is indicated by the LEDs. Points that are awarded to a player for a correct answer are determined by spinning the dial as described above in detail. Points that are deducted from a player's score might be a fraction of the available points (i.e., points that are pointed at by the pointer). Alternatively, the deducted points might be a predetermined number of points. The dial options: 2× points, raid!, and surprise are configured to operate similar to the manner of operation described above. Game three might be played in rounds as described above with bonus games offered for play between rounds. The bonus game is described in detail above. Game three might be won in a similar manner as games one and two described above.

The game apparatus is configured to include a number (e.g., three) of sets of categories and their associated lists of answers. Each set of categories and answers is configured for a select age group (e.g., set one for players five to eight years of age, set two for players eight to eleven years of age, and set three for players eleven years of age and older). The game apparatus at the beginning of game three might be configured to direct the players to choose one or more sets of categories and answers that will be used for playing game three.

Game four, like games one and two, is generally a question and answer game. Game four differs from games one and two in that each player of game four may choose one or more sets of questions and answers that will be directed to the player during the game. That is, each player receives questions from the set of questions that the player selects, and will not receive questions from a set of questions not selected by the player. However, two or more players may select to receive questions from the same or different sets of questions. For example, two children that are six years old might choose to receive questions from the first set of questions. A child that is ten years old might choose to receive questions from the second set of questions. And a parent might choose to receive questions from the third set of questions. The children that are six, will receive questions from the first set of questions, but will not receive questions from the second and third sets of questions that were chosen by the ten year old player and the parent. It should be understood that the foregoing described set selections are exemplary, and that any player may select one or more of any of the sets of questions available for play in game four. At the start of game four, the game apparatus might output audible directions for the players to select one or more sets of questions that the players will answer questions from during play. For example, each set of answer buttons might be respectively associated with the sets of questions and might be temporarily configured by the processor as a selection device for selecting a set of questions for game play. These associations might be communicated to the players in the audible direction.

According to one embodiment, in game four mode, the players take turns answering questions. Each player spins the dial during their turn to play to determine the number of points the player will play for. The dial options 2× point, raid!, and surprise are configured to operate as described above with respect to game one. The game apparatus might be configured to prompt the players with an audible command at the beginning of their turn to spin the dial. After a question's point value is determined, the game apparatus is configured to audibly direct a question to a player whose turn it is to play. After the question is asked, the game apparatus is configured to audibly output a number of answers (e.g., three answers that are respectively associated with the answer buttons of each set of answer buttons). A player may garner points by answering the question correctly by pressing the answer button associated with the correct answer.

According to one embodiment, the repeat button is configured to be pressed by a player to trigger the game apparatus to repeat a question. According to one embodiment, the player may press the repeat button a select number of times (e.g., once) without a point penalty. If the player presses the repeat button more than the select number of times, the player might receive a fraction of the available points available if the player answers the question correctly.

After the question is answered, the game apparatus provides another player a turn to spin the dial and answer a question from the set of questions that the other player has chosen to receive questions from. The game apparatus is configured to continue to ask questions of players until a player has won game four or the players stop playing. A player might win game four similarly to game one, which is described above in detail.

According to one embodiment of game four, the game apparatus is configured to allow players to bet whether another player will answer a question incorrectly. According to various specific embodiments, players may bet before or after a player whose turn it is to play spins the dial, before or after this player's question is audibly output, before or after the answers are audibly output or at other appropriate instances in the game. The processor might temporarily configure the player-recognition buttons of the betting players to accept bets from the betting players. The betting players might bet a predetermined number of points, such as a fraction (e.g., half) of the points pointed at by the pointer. If the player whose turn it is to answer a question answers their question correctly, then the processor is configured to award the points indicated by the pointer to this player and to deduct the predetermined number of points from the betting players. The game apparatus might not deduct points from the player whose turn it is to play if this player answers the question incorrectly, but will award points to the betting players. Players who are permitted by the game apparatus to bet may decline to bet. The game apparatus might be configured to interpret no button presses by a betting player as a decline to bet, or the game apparatus might configured one or more control buttons to pressed to indicate that a player has declined to bet. For example, the game apparatus might be configured to interpret two presses of the player-recognition button as a decline to bet, or the game apparatus might temporarily configure one of the answer buttons as a button for declining to bet. Betting provides for layered game strategy among players. For example, a player whose turn it is may intentionally not answer a question correctly to help another player advance in the game, a player that is a betting player may decline to bet against a player they perceive as a strong player or might bet a against a player that is perceived as a weak player. While game four has been described generally as a question and answer game, the game might be configured as an answer and question game similar to game two described above.

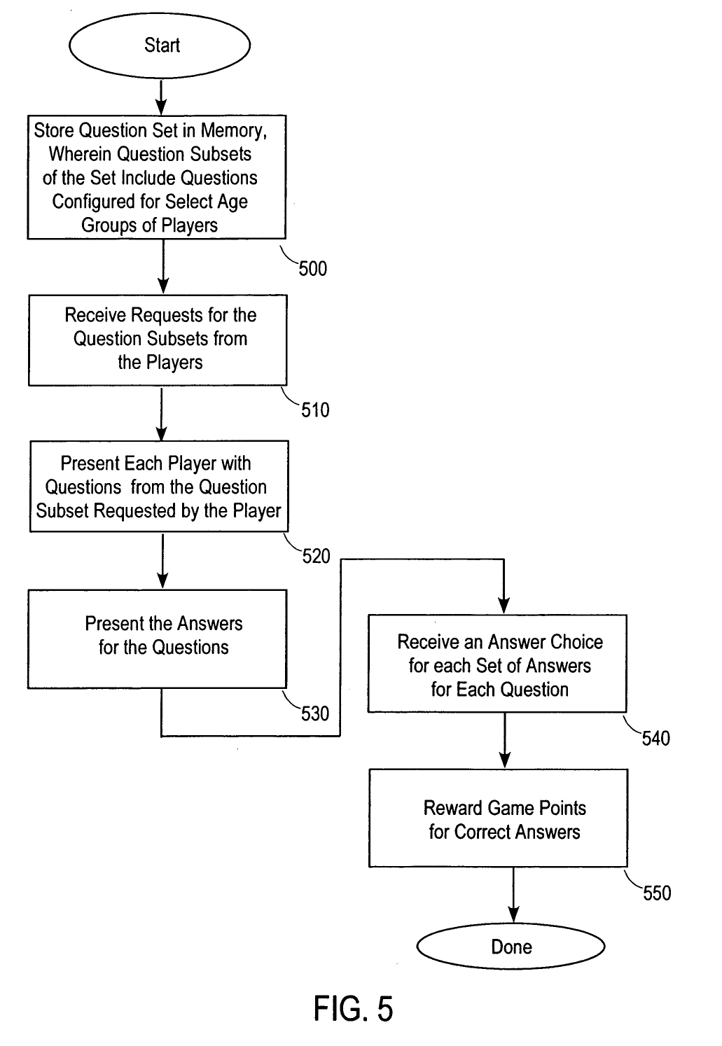

FIG. 5 is a high-level flow chart having steps for the operation of an electronic game that is configured to provide a number of sets of questions of various difficulty from which players may choose for playing the electronic game. Each set of questions may be configured for players within a select age group. The high-level flow chart is merely exemplary, and those of skill in the art will recognize various steps that might be added, deleted, and/or modified and are considered to be within the purview of the present invention. Therefore, the exemplary embodiment should not be viewed as limiting the invention as defined by the claims. At 500, a set of questions is stored in the electronic game. Each set of questions includes a plurality of subsets of questions. Each subset of questions includes questions that are configured to be answered by players having a select age or an age higher than the select age. Each select age that is associated with each subset of questions is different from other select ages associated with other subsets of questions. At 510, a plurality of requests is received for the subsets of questions. Each request is a request for one of the subsets of questions and is associated with one of the players. Further, each of the players is associated with one of the subsets of questions. At 520, each of the players is presented one or more of the questions from the subset of questions that is associated with the player. Players might be provided the opportunity to answer questions in successive turns. At 530, a set of answers is presented for each of the questions presented to the users. Each set of the answers might include three or more answers that might be respectively associated with the answer buttons of a number of sets of answer buttons. At 540, an answer choice is received for each set of answers. At 550, a game benefit, such as game points, is awarded for each correct answer choice. A player might win a game played if the player has the largest number of points after the game has ended. A game might end after a predetermined period of time, after a predetermined number of questions has been asked and answered, or after one of the player's points reaches a predetermined number of points.

Any one or more features of any embodiment of the invention may be combined with any one or more other features of any other embodiment of the invention, without departing from the scope of the invention.

Also, it should be understood that the embodiments of the invention as described above can be implemented in the form of control logic using computer software in a modular or integrated manner. Based on the disclosure and teachings provided herein, a person of ordinary skill in the art will know and appreciate other ways and/or methods to implement the present invention using any suitable combination of hardware and software. Computer code or instructions for performing any of the functions described herein may be stored in a memory and may be executed as a processor as known by those of ordinary skill in the art.

It is also understood that the examples and embodiments described above are for illustrative purposes only and that various modifications or changes in light thereof will be suggested to persons skilled in the art and are to be included within the spirit and purview of this application and the scope of the appended claims. For example, while game apparatus has been described as an electronic game, games one to four might be configured as card based games, wherein sets of questions are placed on sets of cards for game play. Further, while games one to four have been described as being configured to play on a game apparatus, these games might be configured for play on a personal computer, a handheld device (e.g., a personal digital assistant) or the like. Further yet, while the game apparatus has been described as being configured for multiple player play, the game apparatus might be configured for play by a single player. Additionally, while the game apparatus has been described as being configured for up to four players, the game apparatus might be configured for play by more than four players. Therefore, the above description should not be taken as limiting the scope of the invention as defined by the claims.

1. An electronic device for use by users having different levels of skill or intelligence, the device comprising:
a memory configured to store sets of questions, each of the sets of questions being configured to be answerable by the users having different levels of skill or intelligence; and
a processor operatively coupled to the memory and configured to present the different sets of questions to the different users having different levels of skill or intelligence during a game in which the different users compete against each other.

2. The electronic device of claim 1, wherein the different users include a child and an adult, and wherein the child and the adult compete against each other.

3. The electronic device of claim 1, wherein the memory is configured to store sets of answers for the sets of questions.

4. The electronic device of claim 1, wherein the processor is adapted to award points based on correct answers to the questions.

5. The electronic device of claim 1, wherein the different users have different ages.

6. An electronic device comprising:
a memory configured to store sets of questions and sets of answers to the questions, each of the sets of questions being configured to be answerable by users having a select age or an age higher than the select age; and
a processor operatively coupled to the memory and configured to:
receive at least one request for presenting questions from one or more of the sets of questions, and based on the request present at least one question from the one or more sets of question,
present a set of answers to the at least one question,
receive an answer choice,
determine whether the answer choice is a correct choice, and
award a set of points if the answer choice is the correct choice.

7. The electronic device of claim 6, further comprising an audio-output unit operatively coupled to the processor and configured to audibly present the at least one question and the set of answers to the at least one question.

8. The electronic device of claim 6, further comprising a plurality of sets of answer buttons, wherein the answer buttons of each of the sets of answer buttons are respectively associated with the answers to the questions, and wherein the answer buttons are configured to be activated by one or more users to present the answer choices to the processor.

9. The electronic device of claim 6, further comprising a plurality of player-recognition buttons, wherein the processor is configured to detect a first activated player-recognition buttons and provide an opportunity to answer the at least one question to a user that activated the first activated player-recognition button.

10. The electronic device of claim 6, further comprising a plurality of sets of lights operatively coupled to the processor, each set of light being configured to be lighted by a processor command issued by the processor to indicate a total number of points associated with correctly answered questions.

11. The electronic device of claim 6, further comprising a repeat button operatively coupled to the processor and configured to trigger the processor to present an additional time the at least one question from the one or more sets of question.

12. The electronic device of claim 6, further comprising a dial operatively coupled to the processor and configured to be spun by a user, wherein the dial includes a plurality of point options, and wherein at least one of the point options is selectable by spinning the dial.

13. The electronic device of claim 6, wherein each of the select ages is a different age.

14. The electronic device of claim 6, wherein the electronic device is an electronic game device configured to be played by a plurality of users that has a variety of ages, and wherein the processor is configured selectively provide the questions to the users based on the user's ages.

15. A game comprising the electronic device of claim 6.

16. A electronic game comprising:
a processor configured to:
receive a plurality of requests from users for game questions from a plurality of sets of games questions, each of the sets of game questions being configured to be answerable by users having at least a select age, wherein the select ages are different ages, and
provide each of the users the game questions requested by the users during play of one or more game options.

17. The electronic game of claim 16, wherein the plurality of sets of questions includes at least three sets of questions.

18. The electronic game of claim 16, wherein the processor is further configured to receive bets from one or more of the users that another of the users will answer one of the questions presented to the other user incorrectly, wherein if the other user answers this question correctly, then the other user is awarded a game benefit and the one or more of the users loose a game benefit, and wherein if the other user answers this question incorrectly, then the one or more of the users will receive a game benefit.

19. The electronic game of claim 16, further comprising:
a memory configured to store the sets of game questions; and
a memory slot configured to receive a memory card that includes additional sets of game questions that the processor is configured to load into the memory.

20. A user interactive electronic method comprising:
storing a set of questions that includes a plurality of subsets of questions, wherein each of the subsets of questions includes questions that are configured to be answered by users having a select age or an age higher than the select age, wherein each select age is different;
receiving a plurality of requests for the subsets of questions, wherein:
each of the request is a request for one of the subsets of questions and is associated with one of the users, and
each of the users is associated with one of the subsets of questions;
presenting to each of the users one or more of the questions from the subset of questions that is associated with the user;
presenting a set of answers for each of the questions presented to the users;
receiving an answer choice for each set of answers; and
awarding a game benefit for each of the received answer choices that is a correct answer choice.

21. The method of claim 20, wherein the step of receiving the plurality of requests includes one or more of the received requests for a plurality of the subsets of questions, and one or more of the users is associated with the plurality of the subsets of questions.

22. The method of claim 20, wherein the step of presenting to each of the users one or more of the questions includes audibly presenting the questions, and the step of presenting the set of answers for each of the questions includes audibly presenting the set of answers for each of the questions.

23. The method of claim 20, wherein the step of receiving the answer choice includes receiving the answer choice from an answer button of a set of answer buttons and activated by one of the users, wherein the answer buttons are respectively associated with the set of answers.

24. The method of claim 20, wherein the step of presenting to each of the users one or more of the questions includes successively presenting the question to the users.

25. The method of claim 20, wherein the step of presenting to each of the users one or more of the questions includes presenting the questions to each of the users as each of the users is the first of the users to activate a player-recognition button.

26. The method of claim 20, further comprising detecting a first input signal from a first activated player-recognition button of a plurality of player-recognition buttons; and
providing an opportunity to answer the question to the user who first activated this player-recognition button.

27. The method of claim 20, further detecting a position of a dial spun by one of the users to determine the player benefit.

28. The method of claim 20, further comprising lighting one or more lights to indicate a cumulative player benefit received by each user.

29. The method of claim 20, wherein the player benefits are points.

30. The method of claim 20, further comprising:
accepting bets from one or more of the users that another of the users will answer one of the questions presented to the other user incorrectly,
awarding the game benefit to the other player if the other player answers this question correctly
awarding a game benefit to the one or more of the users if the other player does not answer this question correctly.
